(19) United States
(12) Patent Application Publication
(10) Pub. No.: US 2005/0043656 A1
(43) Pub. Date: Feb. 24, 2005

(54) Head massaging device

(76) Inventor: Dwayne Lacey, White Gum Valley (AU)

Correspondence Address: BURR & BROWN, PO BOX 7068, SYRACUSE, NY, 13261-7068, US

(21) Appl. No.: 10/949,796

(22) Filed: Sep. 24, 2004

Related U.S. Application Data
(63) Continuation of application No. 09/935,297, filed on Aug. 22, 2001.
Application No. 09/935,297 is a continuation-in-part of application No. 09/335,714, filed on Jun. 18, 1999, now Pat. No. 6,309,365.

(51) Int. Cl. A61H 7/00; A61H 23/02

(52) U.S. Cl. 601/72; 601/137; 601/133

(57) ABSTRACT

A head massaging device 10 comprises a plurality of resilient fingers 12 defining a head receiving space 14 having an opening 16 at one end formed by the relative juxtaposition of the respective free ends 18 of the fingers 12. The opening 16 is smaller than the size of the head so that in use when the device 10 is lowered onto the head so that the head enters the space 14 through the opening 16, the free ends 18 of the fingers 12 apply pressure to, and thus massage, the head. The massaging effect is enhanced by continuous raising, rotating and lowering of the device 10 on the head.

### FIELD OF THE INVENTION

The present invention relates to a head massaging device.

### BACKGROUND OF THEN INVENTION

Massaging of the human body is well known and is used to achieve numerous different effects. For example massaging may be used in physiotherapy for pain relief or to assist in the healing of damaged muscles or tendons. Massaging is also a well established technique for relieving stress and tension and providing physical relaxation, stimulation and pleasure.

Massaging is predominantly performed by direction hand/finger manipulation although hand held massaging tools are also known. These tools can be broadly categorised into powered (e.g. electrically powered) and manual tools.

Of the manual massaging tools very few have been made specifically for massaging the head and scalp. One tool that is known comprises four small wooden spheres connected to a larger central and raised wooden sphere by short wooden rods. The largest sphere acts as a handle to push and rub the smaller spheres against the body. These spheres can be applied to the head to massage the head and scalp.

### SUMMARY OF THE INVENTION

The present invention was devised to produce an alternate form of manual head/scalp massaging device.

According to one aspect of the present invention there is provided a head massaging device comprising a plurality of resilient fingers, said fingers each having a free end and an opposite end, said opposite ends being coupled together, said fingers defining a head receiving space for receiving a head, said space extending between said free ends and said opposite ends and having an opening at one end formed by a juxtaposition of said free ends of said fingers, said opening being smaller than said head, and at least a portion of said head receiving space having a circumference which exceeds a circumference of said opening whereby, in use, when said device is lowered onto said head so that said head enters said head receiving space through said opening, said free ends of said fingers apply pressure to and thus massage said head.

Preferably the device further includes vibrating means coupled to said opposite ends of said fingers whereby vibrations generated by said vibrating means are transmitted from said opposite ends through said fingers to said free ends.

Preferably the device further includes a handle for receiving opposite ends of said fingers and which is disposed said vibrating means, said handle facilitating gripping and manipulation of said massaging device.

According to a further aspect of the present invention there is provided a head massaging device including at least:
a plurality of resilient and pliable fingers, said fingers each having a free end and an opposite end;
vibrator coupled to said opposite ends whereby vibrations generated by said vibrator are transmitted along said fingers from said opposite ends to said free ends; and
said fingers defining a self-supporting head-receiving space for receiving a head, said space extending between said free ends and said opposite ends and having a self-maintained opening at one end formed by a juxtaposition of said free ends of said fingers, said opening being of a circumference smaller than a circumference of said head, whereby said head can fit inside said space with said free ends in contact with said head, and at least a portion of said head-receiving space having a circumference which is greater than said circumference of said opening whereby, in use, when said device is lowered on to said head so that said head enters said head-receiving space through said opening, said free ends of said fingers apply pressure to and thus massage said head.

According to a further aspect of the present invention there is provided a head massaging device including at least:

a plurality of resilient fingers, said fingers each having a free end and an opposite end;

a vibrator coupled to said opposite ends whereby vibrations generated by said vibrator are

transmitted along said fingers from said opposite ends to said free ends; and,

a handle for receiving said opposite ends and in which is disposed said vibrator;

each of said fingers having a transversely extending portion immediately adjacent the handle, each said transversely extending portion being followed by a contiguous portion extending downwardly and inwardly from said transversely extending portion, said contiguous portion terminating in said free end, said intermediate length and continuous length of said fingers together defining a head-receiving space for receiving a space, said space extending between said free ends and said opposite ends and having an opening at one end formed by a juxtaposition of said free ends of said fingers, said opening having a circumference smaller than a circumference of said head, and at least a portion of said head-receiving space having a circumference which exceeds said circumference of said opening whereby, in use, when said device is lowered on to said head so that said head enters said head-receiving space through said opening, said free ends of said fingers apply pressure to and thus massage said head.

Preferably said fingers are electrically conductive.

Preferably said fingers comprise copper wire.

Preferably the fingers are pliable to that the size and shape of the opening can be varied.

Preferably the free end of each finger is smoothly terminated.

Preferably each free end is terminated in a bulb or ball like structure.

Preferably the free end of each fingers terminates in a resin bulb or ball like structure.

Preferably the fingers are made of wire.

Preferably the fingers are electrically conductive.

Preferably the fingers are made of copper wire.

Preferably the head massaging device comprises between four and twenty four fingers.

Preferably the opposite ends of the fingers are connected together.

Preferably the connected opposite ends of the fingers terminate in or otherwise form a handle for gripping and manipulating the massaging device.

### BRIEF DESCRIPTION OF THE DRAWINGS

An embodiment of the present invention will now be described by reference to the accompanying drawings in which:

FIG. 1 is a schematic representation of a first embodiment of the head massaging device; and,

FIG. 2 is a schematic representation of a second embodiment of the head massaging device showing its handle in partial section.

### DETAILED DESCRIPTION OF THE PREFERRED EMBODIMENTS

The head massaging device 10 comprises a plurality of resilient fingers 12 defining a head receiving space 14 having an opening 16 at one end formed by the relative juxtaposition of the respective free ends 18 of the fingers 12. The opening 16 is smaller than the size of the head so that in use when the device 10 is lowered onto the head so that the head enters the space through the opening 16, the free ends 18 of the fingers 12 apply pressure to, and thus massage, the head.

The fingers 12 are pliable so that the size and shape of the openings 16 can be varied to suit different people. That is, the fingers 12 can be bent to ensure that the opening 16 is of a size so that the free ends 18 contact the head/scalp of a person when the device 10 is lowered onto the head with the head entering the space 14 through opening 16.

The characteristics of resilience and pliability of the fingers 12 can be achieved by making the fingers 12 from wire. Copper wire is particularly well suited because of its wide availability and low cost. It may be beneficial for the wire making up the fingers 12 to be electrically conductive, which of course will follow if the wire is made from copper.

To ensure that the free ends 18 do not scratch the scalp, they are smoothly terminated. This can be achieved by terminating the free end of each finger in a bulb or ball like structure. This structure can be formed integrally with the fingers 12. Alternately, bulb or ball like structures can be fixed or otherwise attached to the free ends 18. One way of doing this is to dip the lower ends of the fingers 18 into a resin then lift the fingers 12 out of the resin so that as the resin flows down each of the fingers 12 it collects and forms a droplet depending from the free ends 18 which upon hardening forms the bulb or ball like structure.

Opposite ends 20 of the fingers 12 are coupled or connected together to form part of a handle 22 for gripping and manipulating the device 10. When the fingers 12 are made of wire, the ends 20 can be simply twisted and otherwise wound together. A plastic housing or other sheath 24 can be slipped over the ends 20 to complete the handle 22 and make it easier to grip.

By making the fingers 12 pliable, the device 10 can be easily packaged and stored in a flat rectangular box by simply flattening half of the fingers 12 on opposite sides of the handle 22. When it is desired to use the device 10 the fingers 12 are simply spread out about the handle 22 from the flat condition.

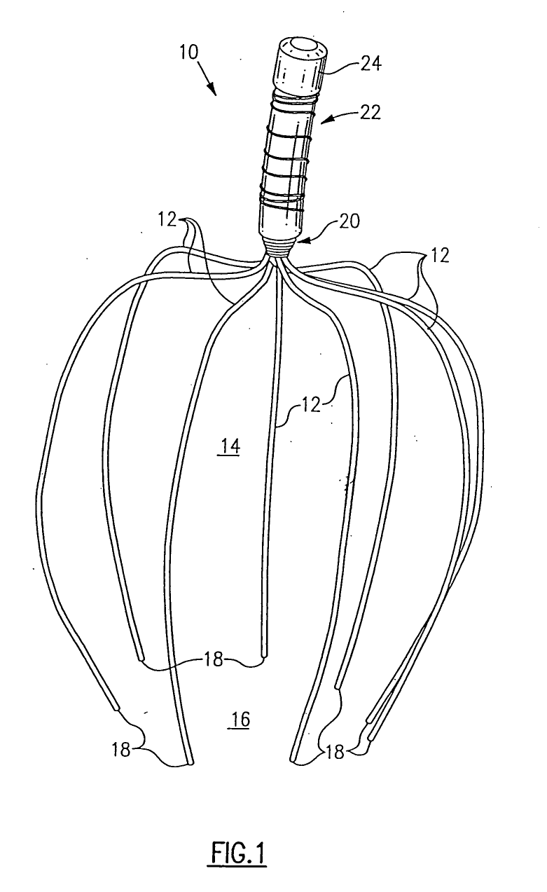

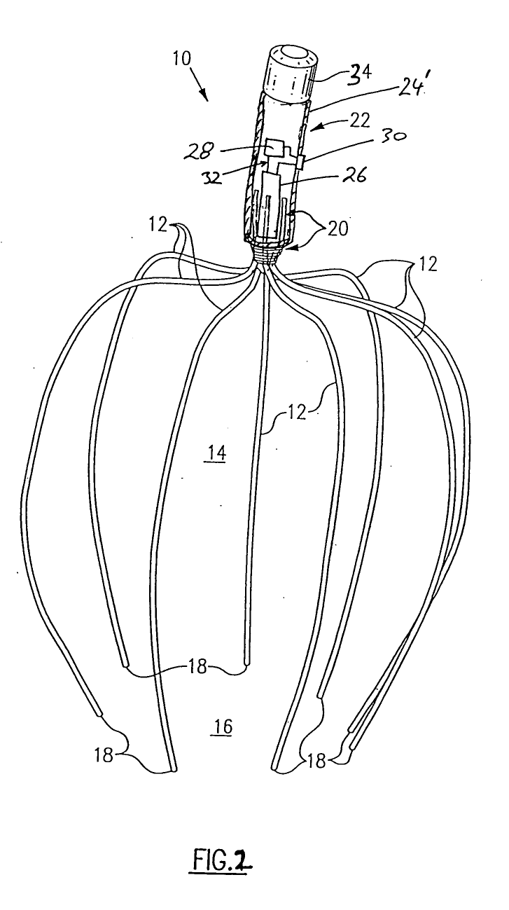

FIG. 2 depicts a second embodiment of the head massaging device 10′ which differs from the device 10 depicted in FIG. 1 by forming the handle 22 with a housing 24′ which receives the free ends 20 of the fingers 12 and in which is disposed a vibrating means (e.g. a vibrator) 26 and battery 28. The vibrator 26 can be in the form of any commercially available battery powered vibrating motor. A switch 30 is provided on the handle 22 for selectively opening and closing an electric circuit 32 coupling the battery 28 to the vibrator 26. In this particular embodiment, the ends 20 of fingers 12 are wedged between the outside of the vibrator 26 and an inside surface of the housing 24′. When the switch 30 is operated to close the circuit 32, an electric current is fed from the battery 28 to the vibrator 26 causing it to vibrate. The vibrations are transmitted along the fingers 12 from the ends 20 to the free ends 18. The housing 24′ is provided with a removable end cap 34 to allow replacement of the battery 28.

Now that embodiments of the massaging device 10, 10′ have been described in detail it will be apparent to those skilled in the relevant arts and numerous modifications and variations can be made without departing from the basic inventive concepts. For example, the illustrated embodiments depict devices 10, 10′ having eight fingers 12. However the device 10, 10′ can be made with any number of fingers with the preferred minimum number being four and preferred maximum number being twenty four. Further, the fingers 12 may be made from plastics, synthetic materials or composites. It is also stressed that the pliability of the fingers 12 is not an essential characteristic of the device 10. If the fingers 12 are made solely from a plastics material then they will still have the resilient characteristic as required by not the preferred feature of pliability. In yet a further variation, each finger 12 can be made as a dual or multi component element having at least a first lower element which includes the free ends 18 being made from a resilient material and a second upper component that can provide the feature of pliability. For example, each finger 12 can be made from the first lower length of plastics material which includes the free end 18 and an upper length say of wire joined to the lower length (for example by an adhesive or epoxy resin) leading to the handle 22 to provide the characteristic of pliability to the finger 12. This then allows the finger 12 to be flattened for storage and opened up for use as well as allowing reshape and resizing of the opening 16. Also, there are numerous alternatives for smoothly terminating the free end 18 of each finger 12. For example, a plastic or metal sleeve having a smooth end can be applied and otherwise affixed to the free end 18 of each finger provided there is a smooth termination. Alternately, the free end 18 of each finger may simply be machined or otherwise worked to provide a smooth termination.

Further, in relation to the vibrating massaging device 10′ depicted in FIG. 2, rather than having the ends 20 of fingers 12 wedged between the vibrator 26 and the inside of housing 24′, other types of mechanical coupling of the vibrations generated by the vibrator 26 can be incorporated. For example, the vibrator 26 can be arranged to transmit vibrations directly to the handle 22, or housing 24′ with the ends 20 coupled to the handle 22 or housing 24′ to receive those vibrations.

All such modifications and variations are deemed to be within the scope of the present invention the nature of which is to be determined from the above description and the appended claims.

1. A hand-held massaging device comprising:
a plurality of resilient fingers, each finger having a free end and an opposite end, said opposite ends being coupled together;
a handle by which a user hand-holds said device, said opposite ends of each finger received in said handle; and,
said fingers defining a head-receiving space for receiving a head, said space extending between said free ends and said opposite ends and having an opening at an end distant said handle formed by a juxtaposition of said free ends of said fingers, said opening being smaller than said head, and at least a portion of said head-receiving space having a circumference that exceeds a circumference of said opening, said free ends of said fingers contacting said head when said head is received in the head-receiving space.

2. The hand-held massaging device according to claim 1 wherein each finger comprises a single integral member.

3. The hand-held device according to claim 1 wherein each finger comprises a single strand of wire or a single length of plastic material.

4. The hand-held massaging device according to claim 1 wherein said handle is elongated and has a longitudinal axis, said longitudinal axis being substantially co-linear with a central axis of said head-receiving space.

5. The hand-held massaging device according to claim 1 further comprising a vibrator coupled to the opposite ends of the fingers.

6. The hand-held massaging device according to claim 1 further comprising a vibrator disposed in said handle, said vibrator generating vibrations that are transmitted to the opposite ends of said fingers and through said fingers to said free ends of said fingers.

7. The hand-held massaging device according to claim 6 wherein the opposite ends of the fingers are wedged between an inside of the handle and the vibrator.

8. The hand-held massaging device according to claim 6 wherein the vibrator transmits vibrations to the handle.

9. A hand-held massaging device comprising:
a plurality of resilient fingers, said fingers each having a free end and an opposite end;
a handle by which a user hand-holds said device, said opposite ends of said fingers received in said handle; and,
an electronic vibrator coupled to said opposite ends of said fingers, said electric vibrator generating vibrations which cause the vibrator to vibrate, said vibrations being transmitted from said vibrator to said opposite ends of said fingers and through said fingers to said free ends of said fingers; said fingers defining a head-receiving space for receiving a head, said space extending between said free ends and said handle and having an opening at one end formed by a juxtaposition of said free ends of said fingers, said opening being smaller than said head, and at least a portion of said head receiving space having a circumference that exceeds a circumference of said opening, said free ends of said fingers contacting said head and applying pressure to said head to massage said head when said head is received in said head receiving space.

10. The hand-held massaging device according to claim 9 wherein each finger comprises a single integral member.

11. The hand-held massaging device according to claim 9 wherein said handle is elongated and has a longitudinal axis, said longitudinal axis being substantially co-linear with a central axis of said head receiving space.

12. The hand-held massaging device according to claim 9 wherein said fingers are pliable so that the size and shape of said opening can be varied.

13. The hand-held massaging device comprising:
a plurality of resilient and pliable fingers, said fingers each having a free end and an opposite end;
a handle by which a user hand-holds the device, said opposite ends of said fingers being received in the handle;
a vibrator coupled to said opposite ends of said fingers, said vibrator generating vibrations which cause the vibrator to vibrate, said vibrations being transmitted from said vibrator to said opposite ends of said fingers and through said fingers to said free ends of said fingers; and,
said fingers defining a self-supporting head-receiving space for receiving a head, said space extending between said free ends and said handle and having a self-maintained opening at one end formed by a juxtaposition of said free ends of said fingers, said opening being of a circumference smaller than a circumference of said head, whereby said head can fit inside said space with said free ends in contact with said head, and at least a portion of said head-receiving space having a circumference which is greater than said circumference of said opening whereby, in use, when said device is lowered on to said head so that said head enters said head-receiving space through said opening, said free ends of said fingers apply pressure to and thus massage said head.

14. The hand-held massaging device according to claim 13 wherein each finger comprises a single integral member.

15. The hand-held massaging device according to claim 13 wherein said handle is elongated and has a longitudinal axis, said longitudinal axis being substantially co-linear with a central axis of said head receiving space.

16. The hand-held massaging device according to claim 13 wherein each of said free ends of each of said fingers is smoothly terminated.

17. The hand-held massaging device according to claim 13 wherein said fingers are electrically conductive.

18. The hand-held massaging device comprising:
a plurality of resilient fingers, said fingers each having a free end and an opposite end;
a vibrator coupled to said opposite ends of said fingers, said vibrator generating vibrations which cause the vibrator to vibrate, said vibrations being transmitted from said vibrator to said opposite ends of said fingers and through said fingers to said free ends of said fingers;
a handle by which the user holds the device, the handle receiving said opposite ends and housing said vibrator; and,
each of said fingers having a transversely extending portion immediately adjacent to the handle, each said transversely extending portion being followed by a contiguous portion extending downwardly and inwardly from said transversely extending portion, said contiguous portion terminating in said free end, said transversely extending portion and said contiguous portion of said fingers together defining a head-receiving space for receiving a head, said space extending between said free ends and said opposite ends and having an opening at one end formed by a juxtaposition of said free ends of said fingers, said opening having a circumference smaller than a circumference of said head, and at least a portion of said head-receiving space having a circumference which exceeds said circumference of said opening whereby, in use, when said device is lowered on to said head so that said head enters said head-receiving space through said opening, said free ends of said fingers apply pressure to and thus massage said head.

19. The device according to claim 18, wherein said fingers are pliable so that the size and shape of said opening can be varied.

20. The device according to claim 18, wherein each said free end of each said finger is smoothly terminated.

21. The hand-held massaging device according to claim 18 wherein each finger comprises a single integral member.

22. The hand-held massaging device according to claim 18 wherein said handle is elongated and has a longitudinal axis, said longitudinal axis being substantially co-linear with a central axis of said head receiving space.

23. A hand-held head massaging device comprising a plurality of resilient non-rotating fingers, said fingers each having a free end and an opposite end, said opposite ends being coupled together, said fingers defining a head-receiving space for receiving a head, said space extending between said free ends and said opposite ends and having an opening at one end formed by a juxtaposition of said free ends of said fingers, said opening being smaller than said head, and at least a portion of said head-receiving space having a circumference which exceeds a circumference of said opening; a handle by which a user hand-holds the device and in which the opposite ends of the fingers are received; and an electric vibrator coupled to said opposite ends of said fingers whereby vibrations generated by said vibrator are transmitted from said opposite ends through said fingers to said free ends whereby, in use, when said device is lowered onto said head so that said head enters said head receiving space through said opening, said free ends of said fingers apply pressure to and thus massage said head.

24. The hand-held massaging device according to claim 23 wherein each finger comprises a single integral member.

25. The hand-held massaging device according to claim 24 wherein said handle is elongated and has a longitudinal axis, said longitudinal axis being substantially co-linear with a central axis of said head receiving space.

26. The device according to claim 25, wherein said fingers are pliable so that the size and shape of said opening can be varied.

27. A hand-held massaging device comprising:
a plurality of resilient and non-rotating fingers, said fingers each having a free end and an opposite end;
a handle by which a user hand-holds said device and to which said fingers are coupled;
a vibrator coupled to said opposite ends whereby said opposite ends are fixed relative to said vibrator and vibrations generated by said vibrator are transmitted along said fingers from said opposite ends to said free ends; and,
said fingers defining a self-supporting head-receiving space for receiving a head, said space extending between said free ends and said opposite ends and having a self-maintained opening at one end formed by a juxtaposition of said free ends of said fingers, said opening being of a circumference smaller than a circumference of said head, whereby said head can fit inside said space with said free ends in contact with said head, and at least a portion of said head-receiving space having a circumference which is greater than said circumference of said opening whereby, in use, when said device is lowered on to said head so that said head enters said head-receiving space through said opening, said free ends of said fingers apply pressure to and thus massage said head.

28. The device according to claim 27, wherein each said free end of each said finger is smoothly terminated.

29. The device according to claim 27, wherein each said free end is terminated in a bulb or ball structure.

30. The device according to claim 27 wherein each finger comprises a single integral member.

31. The hand-held massaging device according to claim 30 wherein said handle is elongated and has a longitudinal axis, said longitudinal axis being substantially co-linear with a central axis of said head receiving space.

32. A hand-held head massaging device comprising:
a plurality of resilient non-rotating fingers, said fingers each having a free end and an opposite end;
a vibrator coupled to said opposite ends whereby vibrations generated by said vibrator are transmitted along said fingers from said opposite ends to said free ends; and
a handle to hand-hold said device, said handle further receiving said opposite ends and receiving said vibrator, said opposite ends fixed relative to said vibrator,
each of said fingers having a traversely extending portion immediately adjacent the handle, each said transversely extending portion being followed by a contiguous portion extending downwardly and inwardly from said traversely extending portion, said contiguous portion terminating in said free end, said transversely extending portion and said contiguous portion of said fingers together defining a head-receiving space for receiving a head, said space extending between said free ends and said opposite ends and having an opening at one end formed by a juxtaposition of said free ends of said fingers, said opening having a circumference smaller than a circumference of said head, and at least a portion of said head-receiving space having a circumference which exceeds said circumference of said opening whereby, in use, when said device is lowered on to said head so that said head enters said head-receiving space through said opening, said free ends of said fingers apply pressure to and thus massage said head.

33. The device according to claim 32, wherein said fingers are pliable so that the size and shape of said opening can be varied.

34. The device according to claim 32, wherein each said free end of each said finger is smoothly terminated.

35. The hand-held massaging device according to claim 32 wherein each finger comprises a single integral member.

36. The hand-held massaging device according to claim 35 wherein said handle is elongated and has a longitudinal axis, said longitudinal axis being substantially co-linear with a central axis of said head receiving space.

37. A method of massaging a human head comprising:
providing a hand-held massaging device by providing a plurality of resilient fingers, each finger having a free end and an opposite end, providing a handle, coupling the opposite ends of the fingers to the handle, arranging the fingers to define a head-receiving space that extends between the handle and the free ends and having an opening at an end distant the handle formed by a juxtaposition of the free ends of the fingers, the opening being smaller than the head and at least a portion of the head-receiving space having a circumference that exceeds a circumference of the opening;
gripping the handle;
lowering the device onto the head so that the head enters the head-receiving space, and the free ends of the fingers contact the head; and,
manipulating the handle to massage the head.

38. The method according to claim 37 further comprising generating vibrations that are transmitted along the fingers to the free ends of the fingers.

39. The method according to claim 38 wherein generating said vibrations comprises providing a vibrator in the handle of the massaging device.

40. The method according to claim 37 wherein arranging the fingers to define a head-receiving space comprises providing the fingers in a flattened condition where fingers lie on opposite sides of the handle, and spreading out the fingers about the handle to form head-receiving space.

41. A method of transporting or storing a hand-held massaging device, the massaging device comprising a plurality or resilient fingers, each finger having a free end and an opposite end, and a handle in which the opposite ends of the fingers are received, the massaging device having a use configuration in which the fingers are arranged to define a head receiving space that extends between the handle and the opposite ends of the fingers and having an opening at one end formed by the juxtaposition of the free ends of the fingers, the opening being smaller than the head, and at least a portion of the head-receiving space having a circumference that exceeds a circumference of the opening; said method comprising flattening the fingers to lie on opposite sides of the handle.
